(19) United States
(12) Patent Application Publication
(10) Pub. No.: US 2013/0260886 A1
(43) Pub. Date: Oct. 3, 2013

(54) Multi-sensory Learning Game System

(71) Applicant: Adam Smith, Pasadena, MD (US)

(72) Inventor: Adam Smith, Pasadena, MD (US)

(21) Appl. No.: 13/848,190

(22) Filed: Mar. 21, 2013

Related U.S. Application Data
(60) Provisional application No. 61/617,423, filed on Mar. 29, 2012.

(51) Int. Cl. A63F 13/00

(52) U.S. Cl. CPC A63F 13/00
USPC 463/36

(57) ABSTRACT

A multi-sensory feedback learning system is provided for helping children learn outside of the classroom. The system includes a depressible game controller mat that is in communication with a monitor or television. Housed within the controller mat are components necessary to store and run a learning video game. Games involving alphabetical characters, numerical characters, and foreign languages are available for children to play via the system. Prompts are displayed on the monitor or audibly through a monitor coupled audio feedback device. Children respond to the prompt by depressing alphanumeric indicia on the controller mat, thereby making answer selections. Feedback on answers is provided in the form of visual, audible, and tactile output from the system. Correct answers are rewarded with points, and a child's total score can be tracked for progress comparison.

### CROSS REFERENCE TO RELATED APPLICATION

This application claims the benefit of U.S. Provisional Application No. 61/617,423 filed on Mar. 29, 2011, entitled “Step N' Learn.” For the purposes of presenting a clear and continuous disclosure, the aforementioned provisional application is incorporated herein by reference.

### BACKGROUND OF THE INVENTION

1. Field of the Invention

The present invention relates to a visual and tactile learning game system and an associated game controller. More specifically, the invention relates to a video game system that teaches spelling and counting using a game controller formed in a mat. The mat has alphanumeric indicia corresponding to game controller inputs. Children step on the mat in response to visual prompts to spell words and earn points. In this way, the game system teaches children to read, write, and count by providing reward incentives. It will be appreciated by children who enjoy physical activities and those who are either having trouble learning, or enjoy trying different methods of learning.

Keeping a child's attention long enough to instill knowledge in them is a common problem faced by parents and teachers. Children have limited attention spans and often find it difficult to focus on a single sensory perception at for any substantial length of time. Because there is significant variety in the function of children's' brains, each child will be able to focus for a length of time different than that of other children. Some children will be able to sit still and absorb an oral lecture while others respond better to visual or tactile techniques. This variation makes it difficult for instructors to determine an appropriate duration of time to teach each lesson or use each learning technique.

Most classroom environments are not conducive to the employment of multiple learning techniques at one time. Typical classrooms contain one teacher and between fifteen and thirty five children. There is thus a substantial potential for variation in learning styles across the students of any particular classroom. Teachers often do not have the time and resources to determine each child's learning style and needs, because the instructor's time is spent teaching to the group and maintaining classroom discipline. To help address this issue, teachers rely on parents, behavioral professionals, and doctors to provide information about each child's needs. Unfortunately, many parents are ill-equipped to make evaluations about a child's learning style. The result is that parents and caregivers often reinforce the same learning techniques as the teacher, and do not explore other ways of learning.

The simplest way for parents and teachers to address the problems arising from children's varied learning styles is to provide activities and learning techniques that utilize multiple forms of sensory stimulation. This approach stimulates a child in several ways and is based on the assumption that the child will respond to at least one form of sensory stimulus. Ideally, the activity can be used both in school and at home to provide regular reinforcement of learned concepts. A portable learning system is needed that provides children with multiple forms of sensory stimulation in order to keep a child's attention and cater to the child's particular learning style.

2. Description of the Prior Art

The video game system of the present invention provides a visual and tactile tool for teaching children to read and count. Visual prompts are displayed on a television screen or monitor for a child to perceive. A participating child responds to the prompts by stepping on corresponding buttons on a mat-style game controller. Proper input by the child will result in visual feedback on the monitor, accumulation of in-game rewards, and optionally audio or tactile feedback. Thus the system and mat give the child real-time updates on how they are progressing. While the prior art does disclose a variety of electronic mats tailored to learning purposes, it does not disclose a system involving a portable video game that incorporates both visual and tactile responses.

Wood, U.S. Pat. No. 5,997,304 discloses a mat with a soft vinyl coated region and a hard plastic region. The soft vinyl region encloses a number of electrical circuits that align with indicia on the vinyl surface. Circuits are electrically linked to a processor, random access memory, and a set of speakers that are disposed within the hard plastic region. Speakers are used to deliver audible prompts to a user in the form of directions about which indicia to depress. When a user steps on or otherwise depresses indicia, a signal is sent to the processor. The processor looks up the associated indicia character and determines whether the input was a proper response to an audible prompt. If the child is correct, an audible message is played that indicates a proper choice. But, if the child depressed the wrong indicia, an incorrect response message is played. In this way, the child learns to select indicia in response to auditory prompts. In the preferred embodiment, the indicia are alphabetic characters and the prompts are character names or phonetic sounds. This learning pad does not include a reward system, a monitor, or any other visual means for receiving feedback about a child's progress. The present invention addresses these shortcomings by providing a video game that tracks a child's progress during the course of play.

Another teaching mat is disclosed in Lin, U.S. Pat. No. 6,761,563. This teaching mat has letters or words incorporated into a soft mat. Beneath each word or letter is a cavity holding an individual audio device. A conductive circuit disposed along the bottom of the word or letter electrically connects with the audio device whenever the associated word or letter is depressed. If a child steps on the letter K, then an auditory message about the letter K is played. The mat thus teaches children to associate letters and words with their names and phonetic sounds. This device does not include a monitor, a visual feedback means, or a reward system. The Lin device may be useful to very small children who are beginning to understand spelling but is not suited to teaching word structure and spelling, because it does not offer multiple means of reinforcement. The present video game system solves these problems and provides a way to teach children spelling, math, and vocabulary, while providing a physical activity.

Video game systems that incorporate game pad controllers are also known in the art. Some of these systems are arcade machines with large screen displays and pressure-sensitive dance pads built into a large rigid housing. Players stand on the dance pads and tap their feet on arrow shaped indicia on the pad in accordance with arrows displayed on the monitor. Correct correlation of visual prompts to dance pad indicia results in the appearance of on-screen decoration and accumulation of points. An example of such systems is disclosed in Suzuki, U.S. Pat. No. 6,227,968. These systems are large and cumbersome, and though they are highly popular in arcades, they are not suited for in home use and are not easily portable. Similar systems can be used in a person's home. Chiwata, U.S. patent Application Publication No. 2007/0079690 discloses a video game system that uses one or more mat style game controllers, a monitor, and a video game system to facilitate a dance competition amongst users. The dance mats do not display indicia associated with alphanumeric characters. Further, the system of Chiwata does not contain spelling information or math exercises. The present invention is a learning video game having a mat having a number of alphanumeric characters and a storage memory containing a voluminous word bank and arithmetic problem bank. The on-screen prompts may require that a player depress indicia that do not have an on-screen match. For example if the user is asked what 4+4 equals, the number 8 must be depressed to obtain points. Thus the present invention is substantially more complicated and useful than the arcade games of Suzuki and Chiwata.

The present invention provides an easy to use and portable video game system for teaching children to spell and perform mathematical calculations. It substantially diverges in design elements from the prior art and consequently it is clear that there is a need in the art for an improvement to existing spelling mat devices and dance mat video game systems. In this regard the instant invention substantially fulfills these needs.

### SUMMARY OF THE INVENTION

In view of the foregoing disadvantages inherent in the known types of video game learning systems now present in the prior art, the present invention provides a new mat-style game controller wherein the same can be utilized for providing convenience for the user when learning to spell, count, and do arithmetic.

The video game learning system includes a processing unit, a storage, a memory, a power source, mat-style game controller, a monitor, and a communication means for operatively connecting the controller and monitor. Several game types or game modes are stored on the storage means and run by the processing unit according to a parent's selection of a desired game. The games made include a spelling game, phonics game, counting game, arithmetic game, and a foreign language game. Other games involving alphanumeric character inputs may be used so long as they have an educational theme for children.

Game visuals are displayed on the monitor or television during game play. Colorful graphics and scenes may be depicted in the background while prompts are presented in the on-screen foreground. The prompts will correspond to letters or numbers the child should input or alternatively will ask questions that a child must determine an answer to prior to inputting a response. In this way, the game helps children memorize letters and numbers and also develops analytical abilities. Correct answers will earn points for the player, which are tallied as game play progresses. This point accumulation method provides the child with a sense of being rewarded for accuracy.

A game controller in the form of a flexible mat is included in the system so that children may input characters in response to on-screen prompts. The top surface of the controller has a set of alphanumeric characters. These characters correspond to the letters of an alphabet, and the number of numerals in a counting system of any desired base. Character selection is made by depressing the character indicia on the pad surface, which closes an electrical circuit below the surface and sends an electrical signal to the processing unit. The processing unit determines the origin of the signal and associates a stored character. Based on this association, the processing unit determines whether the input was “right” or “wrong” and appropriate visual or tactile feedback is activated. Visual and audio feedback is emitted through the television or monitor, while tactile feedback is provided via a vibration means within the game controller mat.

It is therefore an object of the present invention to provide a new and improved learning video game system that has all of the advantages of the prior art and none of the disadvantages.

It is therefore an object of the present invention to provide a learning video game that teaches children to not only identify alphanumeric characters but also teaches spelling, counting, and math.

Another object of the present invention is to provide a learning video game that can teach children foreign languages.

Yet another object of the present invention is to provide a learning video game that incorporates kinesthetic input to keep players engaged mentally and physically as they learn.

Still another object of the present invention is to provide a learning video game that provides multiple forms of sensory feedback to a player.

A further object of the present invention is to provide a reward system within the video game to incentivize children to practice more and attempt higher complexity levels within the game.

A still further object of the present invention is to provide a highly portable learning game system that can be rolled up and taken to another location with a television or monitor. Thus the system is convenient for use with children while a family is travelling. The game can be played in a hotel room, at a relative's house, or at any other location with some open floor space and a television or other monitor.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the system in use by a child. The child stands on the game-controller and depresses alphanumeric indicia with his feet to make selections.

FIG. 2A shows a general system diagram of the learning video game system. Major components of the system and their interactions are displayed.

FIG. 2B shows a general system diagram of an alternate embodiment of the learning video game system. This embodiment uses a removable storage media containing game data that is removably connected to an image processing unit.

FIG. 3 shows a perspective view of the mat-style game controller upper surface. Alphanumeric characters are displayed across the upper surface.

FIG. 4 shows a flow chart of the primary steps taken by the system to affect game play.

FIG. 5 shows an exemplary screen capture from a word spelling game.

FIG. 6 shows an exemplary screen capture from a math game.

FIG. 7 shows an exemplary screen capture of a foreign language learning game.

### DETAILED DESCRIPTION OF THE INVENTION

Reference is made herein to the attached drawings. Like reference numerals are used throughout the drawings to depict like or similar elements of the learning video game system. For the purposes of presenting a brief and clear description of the present invention, the preferred embodiment will be discussed as used for teaching children to spell, count, read and perform mathematical calculations. The figures are intended for representative purposes only and should not be considered to be limiting in any respect.

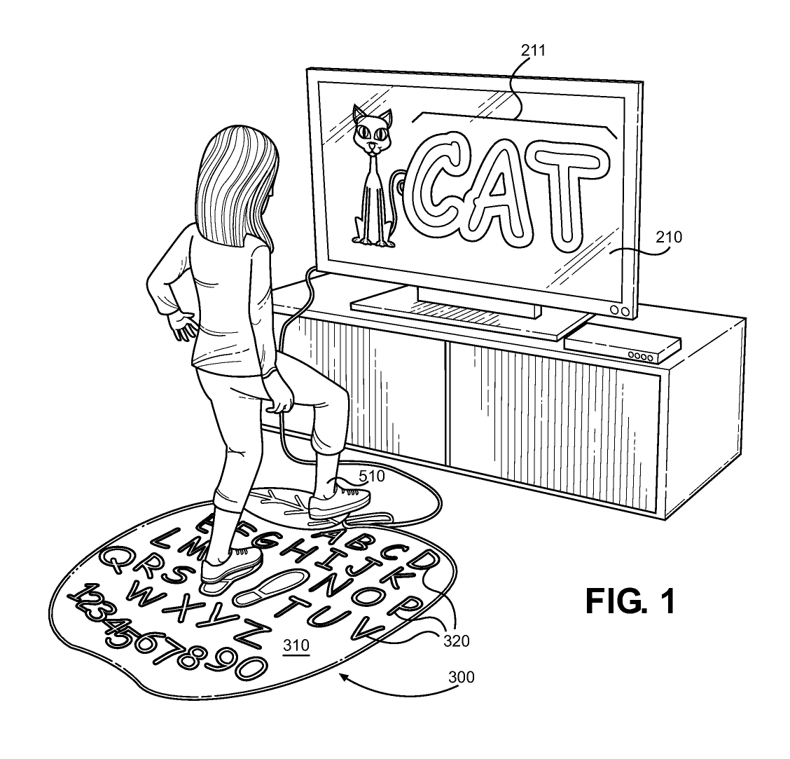

Referring now to FIG. 1, there is shown a depiction of the system in use by a child. The child 500 is standing on the game controller mat 300, which is operatively connected to a television screen 210. The child has a foot 510 raised in the air ready to step on one of the alphanumeric indicia 320 displayed on the mat's surface 310. Specific combinations of indicia are selected in response to an on-screen prompt 211. In the figure, the word “CAT” is displayed on the screen with individual letters highlighted to indicate that correct responses were selected by the child. The selection of correct responses earns the child points within the game, which are summed into a “score.” This score provides the player with a visual indication of his or her progress. Other forms of feedback associated with correct answers may include chimes, and other audible signals that change as the point score increases; and/or vibrations in the mat controller that change as the user's score increases. In this way the system requires both visual and kinesthetic cooperation for input selections and outputs feedback via multiple sensory stimuli.

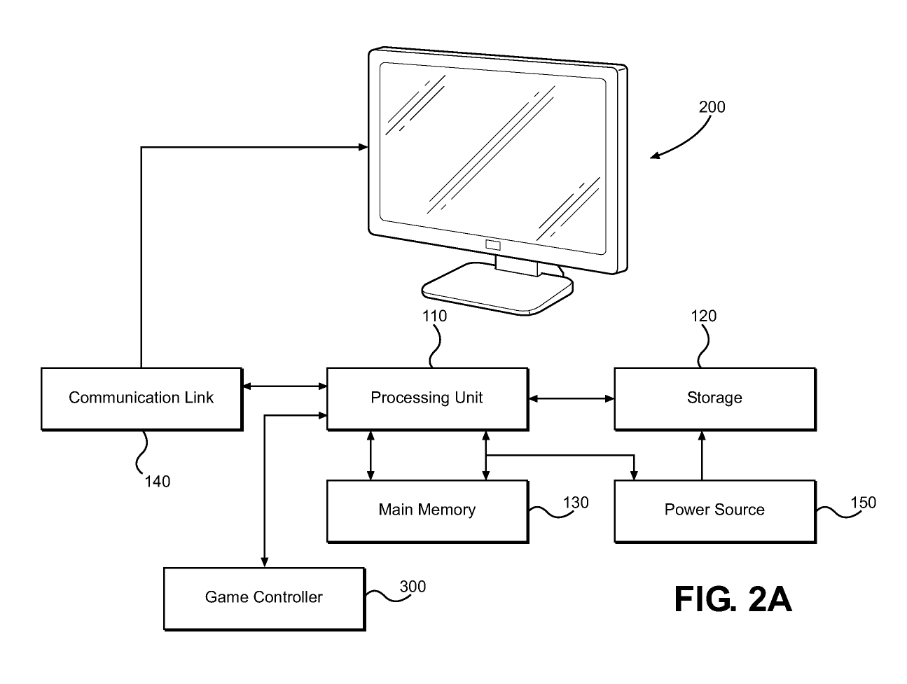

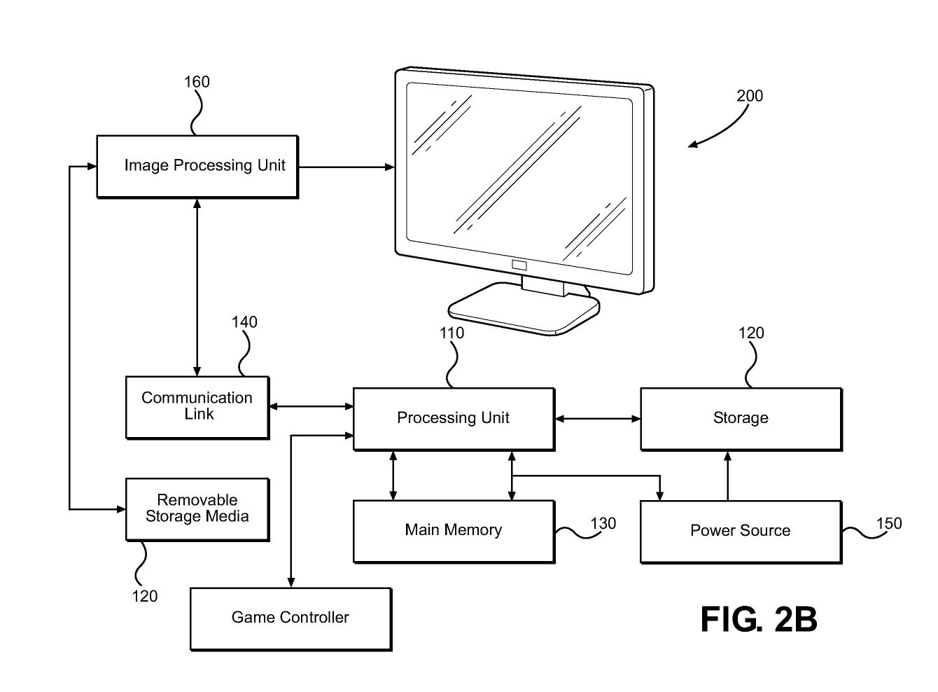

The learning video game system is shown in the general flow diagram of FIG. 2A. The system includes at least a processing unit 110, a storage medium 120, a main memory 130, a communication means 140, a power source 150, a game controller 300, and a monitor 200. In a preferred embodiment, the controller is a pressure sensitive mat that houses the processing unit, storage, main memory, power source, and communication means. The processing unit will likely be a microprocessor, though the size and clock speed of the unit will vary according to production needs. An operating system, game software, and data associated with the video game are stored on the storage medium. An example of such a storage medium is a hard drive. The main memory is a random access memory (RAM). which facilitates loading and unloading of requested software application sectors such as graphics, audio, and the like. A communication link is also included for operatively connecting the game controller to the monitor. Audiovisual inputs such as A/V, hdmi, component and other interface types may be used. A physical cable may connect the game controller and the monitor or the controller may contain a wireless transmission antenna that communicates with a small receiver that is removably plugged into a monitor. For example, an A/V or component cable may extend from the controller mat to the A/V or component inputs of a television screen or monitor. Alternatively, a Bluetooth or radio antenna may be housed within the controller mat and in communication with a small receiving antenna that is housed within a small casing, which is plugged into the A/V or component ports of the television or monitor. These individual components are known in the art of video game systems and small electronics. One of ordinary skill will be able to select the precise make and model of individual components and operatively connect them in a way suited to the needs of the particular components.

When the power source is activated, essential portions of the operating system are loaded from the storage media into the main memory. Game initialization information is also loaded into main memory as part of a start up sequence. A part of this sequence will include video and audio outputs, which are sent to the monitor via the communication link. As the user begins to make selections via the game controller, input is loaded into memory, processed via the processing unit and the corresponding information is looked up in the storage medium. Visual and audio output signals are sent to the monitor to provide audiovisual feedback to a user. An optional secondary output signal may be sent to the game controller activating a vibration motor that agitates the game controller, thereby providing tactile feedback to the user.

An alternative embodiment is shown in FIG. 2B, wherein the system as described above further includes a removable storage medium 170 and an image processing unit 160. The removable storage medium is a DVD, CD-ROM, Blu-ray disc, flash drive or other removable medium on which data and software can be stored. An image processing unit capable of reading and processing the material on the removable storage medium is connected to the monitor and in communication with the game controller via the communication link. DVD players, personal computers, and Blu-ray players are ideal for use as image processing units. The image processing unit should be physically connected to the monitor to maximize optical quality, but the communication link may be wireless or cable based. In this embodiment, the components housed within the game controller 300 are used for receiving and processing controller input and tactile feedback, but are not responsible for audio and video output.

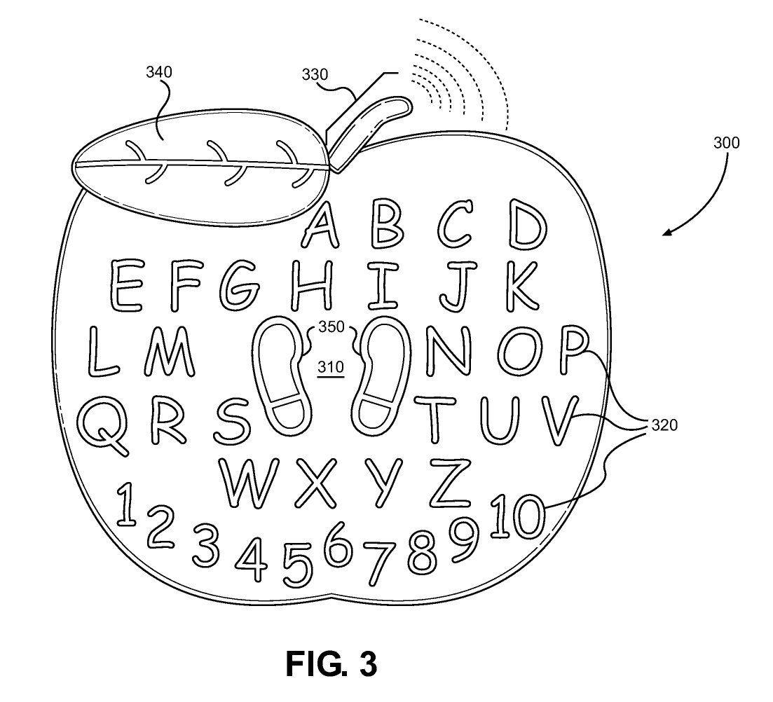

An exemplary game controller mat 300 is shown in FIG. 3. The controller mat is a large flexible pad with alphanumeric indicia 320 displayed on an upper surface 310. Below each indicium, within the mat, is an open electrical circuit. Depression of the indicia closes the circuit resulting in the flow of electrical pulses to the processing unit. The circuits are jointly connected to the input terminal of the processing unit. A neutral zone 350 is also included so that a player may stand on the controller mat without making a selection. The neutral zone is thus free from underlying circuitry. Here, this zone is depicted as a pair of feet shaped indicia.

One or more small vibrating motors are connected to an output terminal of the processing unit. These vibrators may be disposed throughout the mat, or located in a single location. Greater tactile feedback is provided by dispersing the vibration motors throughout the mat. When a child makes a selection the vibrating motors may be initialized according to pre-set vibration patterns. For example a correct selection of indicia may initialize a gentle steady vibration for 1 second, while an incorrect selection may result in several short vibrating pulses. Another output terminal of the processing unit is connected to the communication link to initialize audio and video playback. Video and audio output is also reactive to user inputs, but may be substantially more varied than vibration pattern output. Visual output may include blinking, variations in screen color or background patterns, and the appearance of characters, images or patterns that were not previously present on the game screen. Audio output may include sounds of clapping, cheering, musical chimes, buzzers, alarms, or other audible indicators of a correct or incorrect answer.

The mat is constructed of several layers of insulating material. At least one upper and lower layer is presented to protect electrical circuitry sandwiched therebetween. The interior insulating materials are constructed from soft, shock absorbent materials such as foam. A non-slip shell is used to cover the insulating layers. Different materials may be used on the upper and lower shell surfaces. Soft, flexible, non-slip materials may be used on the upper surface, while a heavier material with a higher coefficient of friction may be used on the bottom. Use of a tackier material on the controller mat bottom will reduce sliding of the mat while a child is playing the game. Material construction and dimension of the controller mat may vary. But the controller mat should remain lightweight and flexible enough to roll up or fold up, for easy transportation by parents and care-givers.

One region of the controller mat is not flexible, but has a hard plastic or rubber casing. The protective housing region 330 is shown in the diagram as the stem of an apple shaped mat. This region houses the processing unit, power source, communication link, main memory, and storage. An area along the controller mat perimeter is ideal for placement of the protective housing, because it will be out of the area used for game play. A power switch may be disposed on the side of the protective housing, or may be a button 340 on the upper surface of the mat, such as the leaf of the depicted apple. Protection of the internal system components is essential to prevent them from being damaged by children stomping on the controller mat. Size and placement of the protective housing will not prevent easy storage of the controller mat as described above.

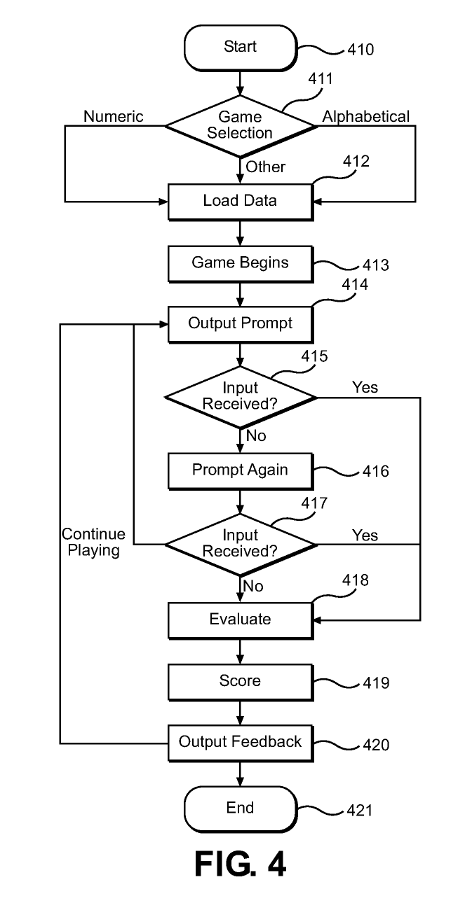

Turning now to FIG. 4 there is shown a flow chart diagram of game play progression. When the learning video game starts 410 a choice of games is displayed to the user. Users may select from games involving alphabetical associations such as spelling, or character recognition games; numeric games such as counting, or arithmetic games; or other games such as foreign language teachers. Game selection is made by the user via depression of indicia on the game controller mat. The selected game data is loaded 412 and game play begins 413. Standard flow of game play involves the display of a prompt on the monitor 414 to which a response is entered by the player. Feedback receipt and award accumulation are based on correctness of user responses. After the system has displayed a prompt such as a picture of a cat or the phrase “what animal says meow,” the user depresses alphanumeric indicia on the controller mat with his or her foot in an attempt to spell out the correct answer. To reinforce different learning styles, the system may also play audio prompts relating to the on-screen prompt, or may merely play an audio prompt without an on-screen prompt. Input from the player is received by the system and evaluated for correctness 415. If the answer is correct a point score is evaluated 418 for the correct answer based on the level of difficulty and the number of tries the player made before getting the correct answer. If the entered input constitutes an incorrect response, the system will prompt the user again 416. It is preferred that follow-up prompts are presented in a different sensory format than those prior. By way of example, if the first prompt was a picture of a cat, the second prompt might audibly ask the user “what animal says meow?” Similarly, if the first prompt was the visual question “what animal says meow” a picture of a cat might be displayed thereafter. Again, the player will input a response by pressing his or her feet downward on corresponding controller mat indicia. The received response is evaluated for correctness 417. If the response is correct then a score is evaluated 418 and added to the player's total score calculation 419. Feedback is produced in the form of tactile, visual, or audio output 420. A correct answer may cause flashing lights to appear on the monitor, a perfect answer might also make the controller mat vibrate. These are examples of a few of the many forms of feedback that can be produced by the system. The game then returns to the prompting step 414 and continues until a user elects to end 421. In a preferred embodiment the player can input his or her name into the system to keep track of high scores. In this way, players can compare their progress on different games. This allows multiple children to use the same video game system and compare their progress to that of other players.

In an alternate embodiment the learning video game system includes a two player competition mode. Game play in this mode commences similarly to that of the single player games, but incorporates a split screen game screen on the monitor. Players receive the same prompt and receive points based on how fast they can input the correct answer. Alternatively, the first player to input the correct answer may receive all the points for that round. This version of the learning game system involves the use of two game controller mats. It is better suited to the removable storage medium embodiment of the system, because the image processing unit can better handle the optical throughput necessary to display two versions of the game screen at once. However, it is not desired that the learning video game system for two players should be limited to the removable storage medium embodiment.

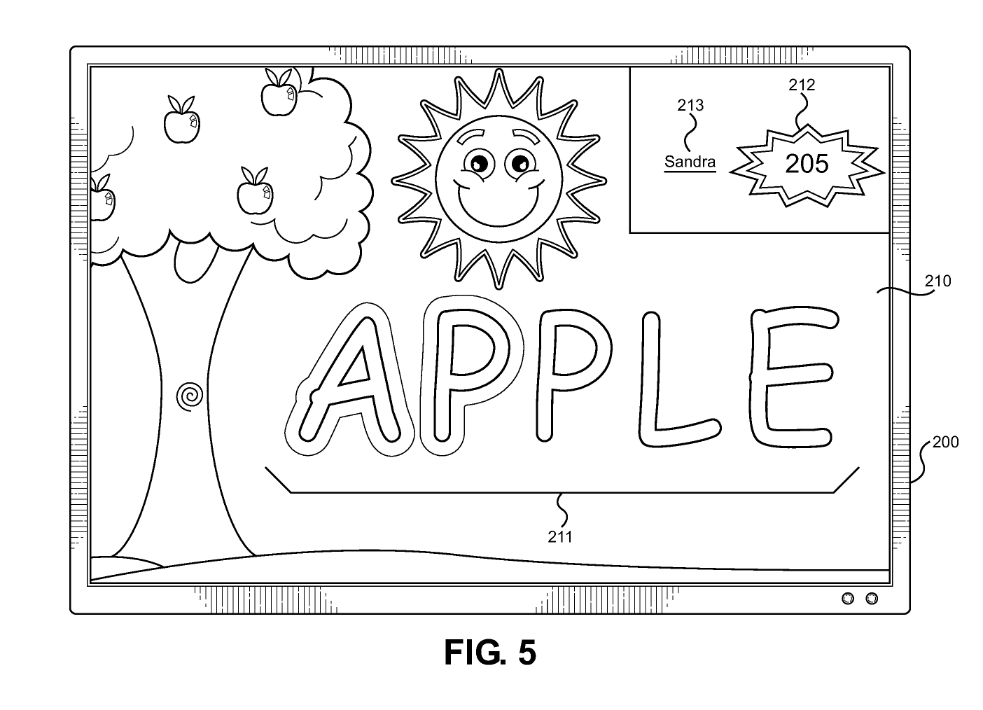

Examples of system visual output are depicted in FIGS. 5-7. In FIG. 5 a spelling game is shown as it might appear on a monitor 200. The screen 210 shows an apple tree and happy sun in the background to present a whimsical context for the presented prompt. Background scenes may change to match the prompt or may be static during a particular round of play. Coordinating the background screen with the current prompt stimulates children who are graphical learners as opposed to those who learn best by reading characters. Thus, children who associate best with graphical depictions of concepts will learn to associate the background images with the prompted question or characters. It will also help children who have not yet memorized all the alphabet characters and have difficulty reading the prompts. In this figure, the current prompt 211 is the word “Apple” The child must use his or her feet to select the characters on the controller mat corresponding to the on-screen characters. Correct selections cause the current character to illuminate or gain an aura. Letters “a” and “p” are highlighted, while letters “p”, “l”, “e” remain un-highlighted, thereby indicating that the child is not done spelling the word “apple.: It may also be helpful to have an auditory repetition of the character name upon input or prior to input, thus telling the child what letter was chosen, or what letter should be chosen next. The upper corner of the game screen shows the player's name 213 and current score 212. Play will continue until the child correctly spells the word “apple” or until he or she elects to end the game.

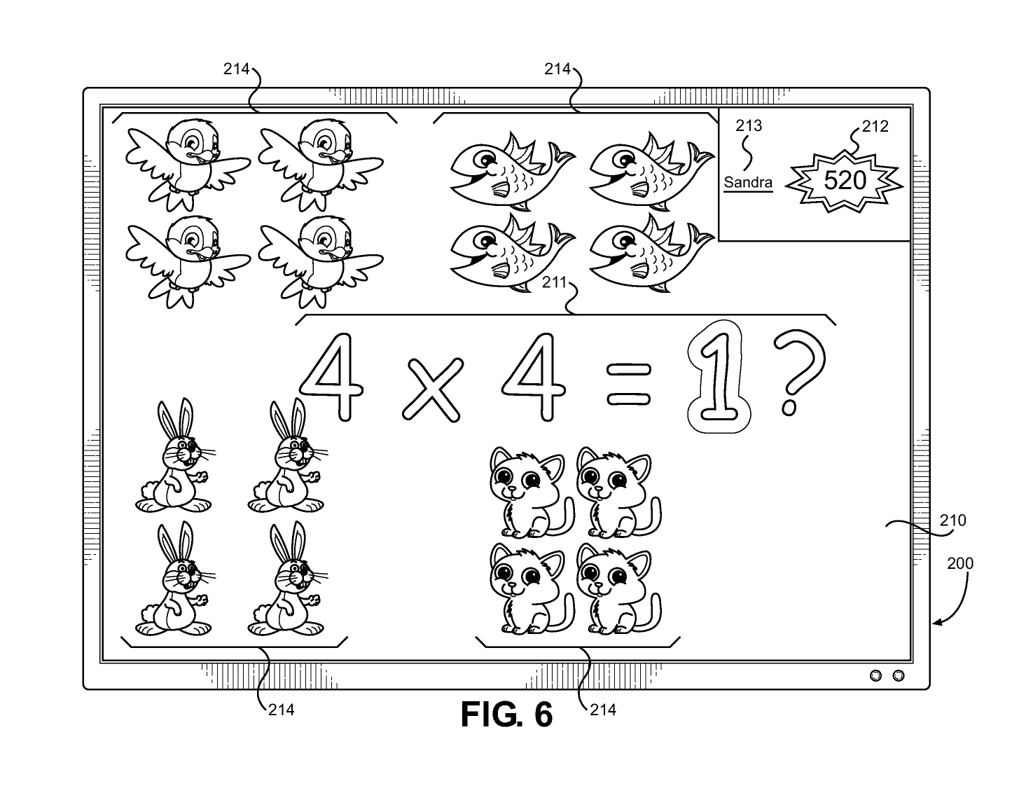

The exemplary game screen shown in FIG. 6 pertains to an arithmetic game. The monitor 200 screen 210 shows multiple prompt types. The prompts 211 are in the form of an arithmetic equation and several groups of animals. Four groups of four animals, each group depicting a different type of animal, are shown to provide a child with a graphical depiction of the prompt equation. Some children are intimidated by mathematical expressions and therefore may become frustrated if presented with just the arithmetic equation. As children progress through the program difficulty levels and become more comfortable with mathematical expressions, the visual representations may be eliminated. Ultimately, the game may rely primarily on audio prompts of the equation, to encourage children to conceptualize mathematic concepts in their head. By way of example, the audible prompt may enunciate the equation “four times four equals?” or say the numbers one at a time, waiting for user input before proceeding, so that the user must input the elements of the equation, which will then appear on screen, before ultimately answering the question. In this figure, the child has correctly selected the number “1” but has not yet input the number “6” to finish off the expression. Once the player completes the equation, points will be added to her score 212, which are displayed next to her name 213 in the corner of the game screen.

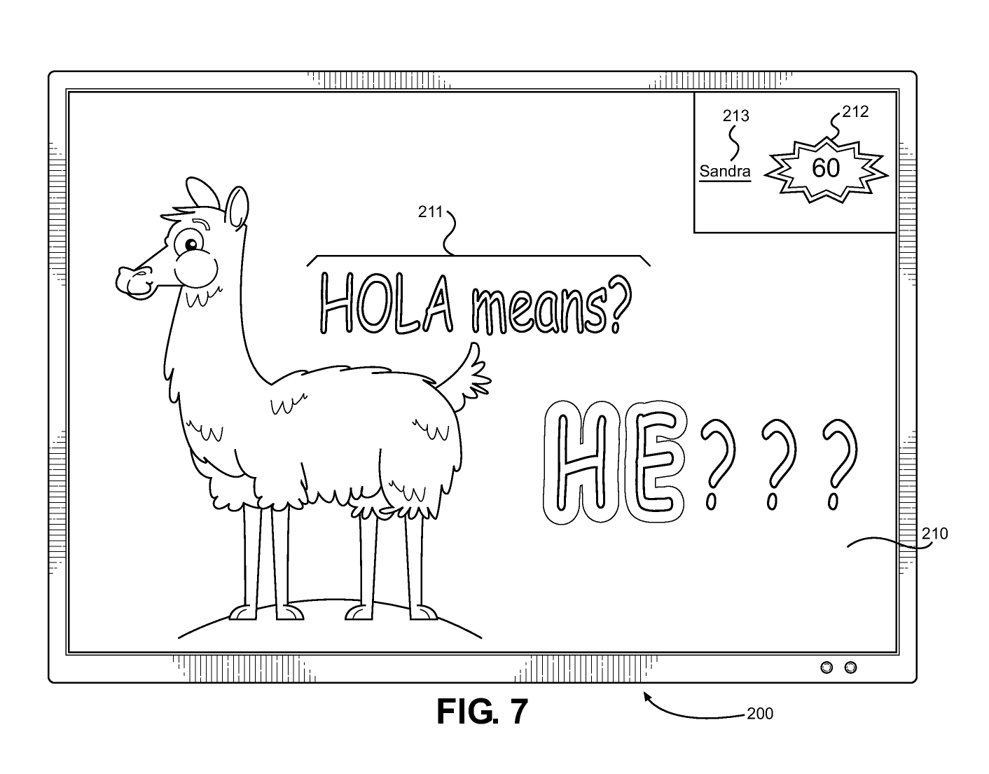

A final example of a game screen in shown in FIG. 7. This screen is associated with a foreign language learning game, intended to teach children the basics of foreign languages. The background image is a static image, or a dynamic one that is unassociated with the particular prompt. In this case, a happy llama is depicted as a whimsical background in a Spanish learning game. Latin music may also be played to add to the general cultural theme. Visual and audio feedback associated with correct and incorrect answers may also be tailored to the language. The word “si” may be substituted for “yes” or “correct” in a Spanish game, while “oui” may be equivalently used in a French game or “ja” in a German game. Here the prompt 211 displayed on the monitor 200 screen 210 asks the player what the word “hola” means. The system waits for the player to spell the word “hello” and highlights correct responses. Points are awarded for correct responses and added to the overall score 212 displayed next to the player's name 213.

In use a parent, teacher or other caregiver plugs the communication link into the monitor or television. The controller mat is then unrolled or unfolded in front of the monitor with the upper surface facing towards the ceiling of a room. Items that a child may collide with or knock over during enthusiastic game play are removed from the surrounding area. The monitor is then turned on, and the game controller mat is powered on, initializing a game start up sequence. A child is stands in the middle of the mat, aligning his or her feet with the depicted neutral zone. A game selection screen will appear on the monitor, prompting the player to select the type of game he or she would like to play. Such prompts may direct children to “step to the right for alphabet game”, “step to the left for other games” and “step on the numbers for a math game.” The child selects a game by stepping as directed, and then waits for a prompt to appear. Prompts will appear on-screen or will be audibly projected from the monitor or coupled speakers. Selections are made by the player via the depressible game controller mat. Upon receipt of a user selection, the system will provide visual, tactile, and/or audio feedback to the user regarding the correctness of the selection. Correct answers will result in accumulating of points. Pints are summed during the course of play and presented as a running score on a portion of the game screen. When the child is done playing the game, he or she can enter their name to save their score for later comparison In this way the child and the parent can keep track of the child's learning progress as represented by game scores.

The present invention is thus a learning video game system that provides a portable and easy to use means for helping children learn. Multiple sensory forms of feedback and provided by the system to stimulate children of all learning styles. Interaction with the system is facilitated by a depressible game controller mat that children mash with their feet. Thus, the system encourages kinesthetic activity by children while they are learning. Children are stimulated physically, visually, and audibly, making it more likely that game lessons will be absorbed and retained. Additionally, the system provides a reward system to incentive children to attempt increasing levels of difficulty and answer questions as quickly as possible. Points are awarded according to the correctness of an answer, the time taken to achieve the correct answer, and the difficulty of the question. Parents can use the multi-sensory learning system to help kids learn outside of the classroom and strengthen the child's mastery of basic concepts.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A multi-sensory feedback video game system for teaching children, comprising:
a monitor;
a game controller mat having an upper and lower surface, wherein said upper surface is covered in indicia of alphanumeric characters comprising of at least a full set of alphabetical characters corresponding to the base language of a video game, and a full set of numeric characters corresponding to a the counting base of a video game;
a processing unit;
a storage, wherein said storage retains software associated with a learning video game;
a main memory;
a communication link;
a power source;
said processing unit, storage, main memory, communication link, and said power source housed within and electrically connected to said game controller mat.;
said communication link operatively connecting said monitor and said game controller and components housed therein.

2) The system of claim 1, further comprising one or more vibration motors disposed within and electrically connected to said game controller mat.

3) The system of claim 1, wherein said learning video game comprises:
a game directed to reading skills;
a game directed to mathematical skills.

4) The system of claim 3, wherein said video game further comprises a game directed to foreign language skills.

5) The system of claim 1, wherein said communication link comprises a cable extending from said game mat controller and having one or more plugs disposed at a distal end, wherein said one or more plugs engages with a corresponding port on said monitor.

6) The system of claim 1, wherein said communication link comprises a wireless communication protocol transmission antenna disposed in said game controller mat and a wireless protocol receiving unit adapted to engage with ports on said monitor.

7) The system of claim 1, wherein said monitor is a television.

8) The system of claim 1, further comprising an audio playback means coupled to said monitor.

9) A multi-sensory feedback video game system for teaching children, comprising:
a monitor;
a game controller mat having an upper and lower surface, wherein said upper surface is covered in indicia of alphanumeric characters comprising of at least a full set of alphabetical characters corresponding to the base language of a video game, and a full set of numeric characters corresponding to a the counting base of a video game;
a processing unit;
a storage, wherein said storage retains software associated with a learning video game;
a main memory;
a communication link;
a power source;
said processing unit, storage, main memory, communication link, and said power source housed within and electrically connected to said game controller mat.;
said communication link operatively connecting said monitor and said game controller and components housed therein,
an image processing unit, operatively connected to said monitor and in communication with said communication link;
a removable storage media, that removably engages with said image processing unit to facilitate data transfer.

10) The system of claim 9, further comprising one or more vibration motors disposed within and electrically connected to said game controller mat.

11) The system of claim 9, wherein said learning video game comprises:
a game directed to reading skills;
a game directed to mathematical skills;

12) The system of claim 11, wherein said video game further comprises a game directed to foreign language skills.

13) The system of claim 9, wherein said communication link comprises a cable extending from said game mat controller and having one or more plugs disposed at a distal end, wherein said one or more plugs engages with a corresponding port on said monitor.

14) The system of claim 9, wherein said communication link comprises a wireless communication protocol transmission antenna disposed in said game controller mat and a wireless protocol receiving unit adapted to engage with ports on said monitor.

15) The system of claim 9, wherein said monitor is a television.

16) The system of claim 9, further comprising an audio playback means coupled to said monitor.
